(19) United States
(12) Patent Application Publication
(10) Pub. No.: US 2007/0194592 A1
(43) Pub. Date: Aug. 23, 2007

(54) Vehicle Carpet System

(75) Inventors: John Lindsay, Port Melbourne (AU); Peter Alan Parsons, Alpendale (AU); Daniel L. Petkoff, Oobleigh East (AU)

Correspondence Address: Thomas Moga;Butzel Long, STONERIDGE WEST, 41000 WOODWARD AVENUE, BLOOMFIELD HILLS, MI, 48304, US

(73) Assignee: FUTURIS AUTOMOTIVE INTERIORS US, INC., Troy, MI (US)

(21) Appl. No.: 11/670,075

(22) Filed: Feb. 1, 2007

(30) Foreign Application Priority Data
Feb. 20, 2006 (AU) 2006900825

(51) Int. Cl. B62D 25/20

(52) U.S. Cl. 296/97.23

(57) ABSTRACT

A vehicle carpet system has a continuous carpet base molded to the shape of the vehicle floor in which it is to be installed. The carpet base includes at least one layer of a molded noise-attenuating material, at least one molded recess formed therein. A removable acoustic carpet module fitted into the at least one recess and held in place by a releasable retainer.

### BACKGROUND OF THE INVENTION

The present invention relates to carpet systems and is particularly concerned with providing a modular carpet system for vehicles, such as automobiles.

Conventional carpet systems for vehicles use a multi layered composite material that includes a relatively expensive, tufted surface across the entire carpet. As much as 70% of this surface is hidden under seats, consoles and the instrument panel. Mats are also often included to protect this expensive surface in the high wear areas such as foot wells. This leads to an expensive total cost of the carpet system as higher cost materials are used in areas where the appearance and functionality (i.e. hard wearing) are not required. Such carpet systems are multi layered products that are made up of a composite of different synthetic materials making the total carpet system less recyclable.

Conventional vehicle carpet systems generally have a uniform level of noise attenuation over the entire surface and do not allow for specific areas of low and high noise attenuation. The addition of noise attenuating material is generally expensive and also adds considerable weight to the total carpet system.

Current carpet systems because of this requirement for noise attenuation are heavy and hence lead to a higher total vehicle mass and the subsequent lowering of vehicle performance in areas such as fuel economy and acceleration.

It is therefore desirable to provide a vehicle carpet system which alleviates at least some of the disadvantages of conventional vehicle carpet systems.

### SUMMARY OF THE INVENTION

According to one aspect of the present invention there is provided a carpet system for vehicles including a continuous carpet base molded to the shape of the vehicle floor in which it is to be installed, the carpet base including at least one layer of a molded noise-attenuating material, at least one molded recess being formed in the carpet base, and at least one removable acoustic carpet module which is adapted to be fitted into the at least one recess in the carpet base.

The carpet system according to the present invention allows for a range of unique materials to be used in both the acoustic modules and continuous carpet base to provide the following features:
The carpet system can be adapted to meet the acoustic requirements set by the vehicle manufacturer.
The adaptability of the system enables weight requirements set by the vehicle manufacturer to be satisfied.
The system allows for maximum recyclability.
Different aesthetic looks can be provided for the acoustic modules and carpet base.
The system allows the replacement of modules due to wear during vehicle life.

The carpet base may be formed from two or more layers each having different properties. Preferably, the carpet base has at least one lower layer of noise-attenuating material, such as a fibrous web, a Hi-Loft felt material or polyurethane foam.

The upper layer of the carpet base is preferably formed from a low cost non woven material which is either thermally bonded or mechanically bonded. It will, however, be appreciated that other materials may be used for the upper layer, including tufted polyamide or polypropylene, poly vinyl chloride (PVC), thermoplastic elastomer (TPE) or thermoplastic olefin (TPO).

In a particularly preferred embodiment, the carpet base in which the recesses are molded has at least one intermediate layer between the upper and lower layers. The intermediate layer forms an acoustic layer designed to absorb noise from the vehicle. The acoustic layer of the carpet base may be formed from a moldable fibrous web, a felt material or from a heavy sound-deadening material such as Ethylene vinyl acetate co-polymer (EVA) or EDPM (Ethylene-Polypropylene-Diene Monomer).

The materials for the layers of the molded carpet base are preferably selected so as to be composed of like or compatible materials to allow for maximum recyclability of the carpet.

The acoustic modules are designed to meet the engineering requirements of the vehicle. Preferably, the acoustic module has a lower acoustic layer providing sound-absorbing or noise-attenuating properties. The lower acoustic layer may be made of a range of materials selected from: a heavy layer of EVA or EDPM; a fibrous web or felt material; PVC; TPO; TPE; polyurethane or polyester foam; or a non-woven thermally or mechanically bonded material. The upper layer providing the top surface of the acoustic module is preferably made from a high wearing material which is selected to meet the requirements of the customer. The material for the upper layer may be selected from: tufted polyamide or polypropylene; PVC; TPO; TPE; rubber; a non-woven thermally bonded material; a non-woven mechanically bonded material; a metallic material; timber or cellulose.

The acoustic module may be locked into the molded recess in the carpet by one of a number of retaining means. In one preferred embodiment, the recess may have a dovetail shape in cross-section with undercut side walls which positively retain the acoustic module in position when the module is inserted into the recess. Alternatively, or additionally, at least one separate retaining member, such as a peg which extends through the layers of the carpet base and the acoustic module, may be provided.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic plan view of a vehicle carpet system in accordance with the present invention;

FIG. 2 is a plan view of one of the acoustic modules of the carpet system of FIG. 1;

FIG. 3 is a section through the carpet base of the system taken on the line A-A of FIG. 1;

FIG. 4 is a sectional view taken on the line B-B of FIG. 1;

FIG. 5 is a section view taken on the line C-C of FIG. 1 showing one form of a retaining means;

FIG. 6 is a sectional view taken on the line D-D of FIG. 2 showing another form of retaining means for securing an acoustic module to the carpet base; and

FIG. 7 is a view similar to FIG. 6 showing a third form of retaining means.

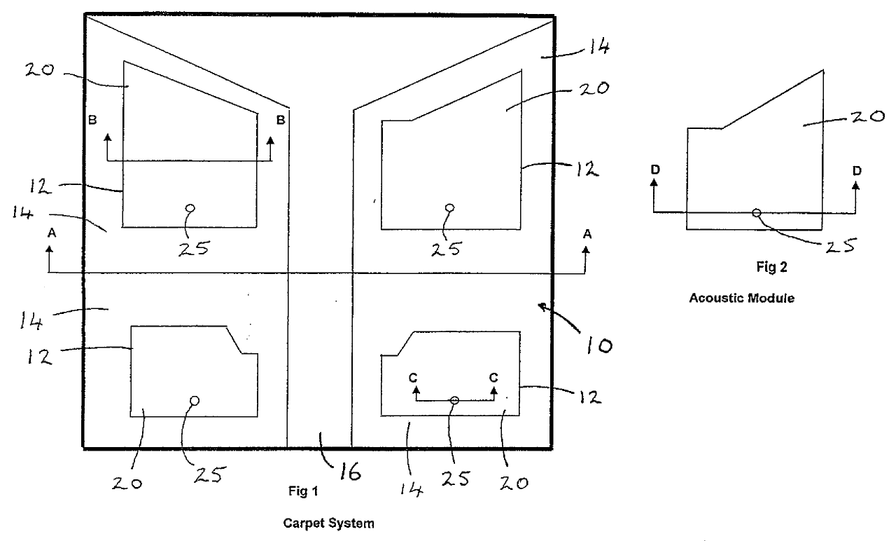

### DESCRIPTION OF THE PREFERRED EMBODIMENT

The module vehicle carpet system shown schematically in FIG. 1 comprises a carpet base 10 which is molded to the shape of the vehicle floor in which it is to be installed, and a plurality of acoustic modules 20 fitted into associated molded recesses 12 in the carpet base 10. As shown in FIG. 1 there are four of the modules 20 located in foot well areas 14 of the carpet base 10. The recesses 12 and modules 20 correspond to the foot wells of a typical four seat configuration: upper left being the driver; upper right being the front seat passenger; and lower being the rear seat passengers. As shown the recesses 12 and modules 20 can have different shapes in plan view.

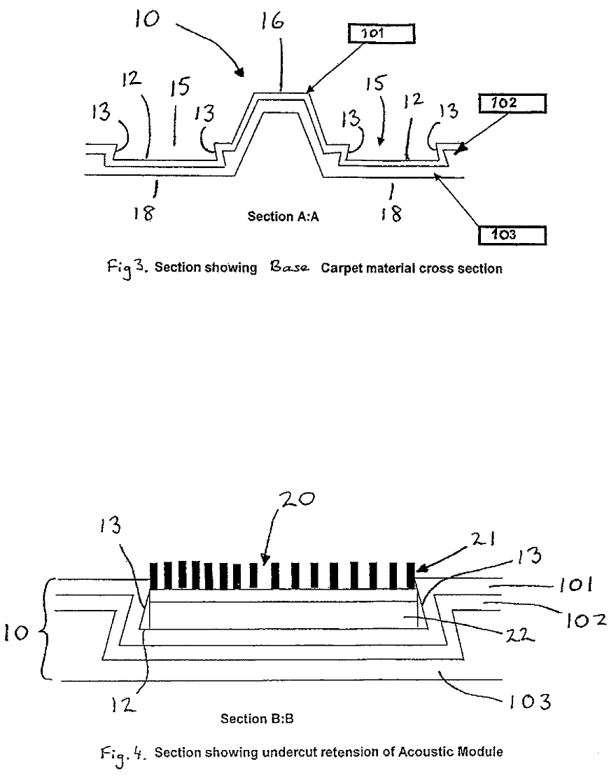

The carpet base 10 is shown in section in FIG. 3 and has a raised central portion 16 with lower portions 18 on either side in the foot well areas 14 where the recesses 12 are provided.

The molded carpet base 10 is formed from three layers 101, 102 and 103. The upper layer 101 provides what is referred to as the “A” surface of the carpet system which is uppermost and visible to the occupant of the vehicle in which the carpet system is installed. The upper layer 101 is preferably formed from a non-woven thermally bonded material which provides a relatively low cost, but aesthetically satisfactory appearance. Other possible materials which may be used for the upper layer include non-woven mechanically bonded materials, PVC, TPO, TPE, tufted polyamide (PA6 or PA6.6) and tufted polypropylene.

The second, intermediate layer 102 is an acoustic layer to be known as the “B” surface and is designed to absorb noise from the vehicle. The acoustic layer may be formed from a moldable fibrous web or a heavy layer of a sound-deadening material, such as EVA or EDPM.

The third, lower layer 103 of the carpet base 10 is to be known as the “C” layer and is provided for noise attenuation. It is preferably formed from a fibrous web or Hi-Loft felt material, or from polyurethane foam.

The recesses 12 of the carpet base 10 shown in FIG. 3 are molded in the shape of a dovetail with undercut side walls 13 designed to retain the acoustic modules 20 securely in position as shown in more detail in FIG. 4. The acoustic modules 20 have a peripheral shape which corresponds to the peripheral shape of the recesses 12 in the carpet base 10, but the transverse dimensions of the acoustic modules 20 are slightly larger than the mouths 15 of the recesses 12 so that the acoustic modules 20 are located in position by the undercut side walls 13 when inserted into the recesses 12. At least the upper layer 101 of the carpet base 10 is formed from a resilient molded material so as to facilitate insertion of the acoustic modules 20 into the recesses.

Each acoustic module 20 has an upper layer 21 and a lower layer 22 as shown in FIG. 4. The upper layer 21 presents an “A” or upper surface which is visible when the carpet system is installed in a vehicle. The lower layer 22 is known as the “B” surface and preferably forms an acoustic layer which is also designed to absorb noise from the vehicle. In addition to being provided in foot well areas 14, acoustic modules 20 may also be provided in recesses in other areas of the carpet base 10 where additional noise absorption/attenuation is required. The lower acoustic layer 22 of the acoustic module 20 may be formed from a range of materials having sound absorbing or noise-attenuating properties, including: a heavy layer of EVA or EDPM; a fibrous web, e.g. of felt material; PVC; TPO; TPE; polyurethane foam; polyester foam; non woven thermally bonded material; or non-woven mechanically bonded material.

The acoustic modules 20 will typically be located in foot wells 14 of the vehicle which can experience a great deal of wear. Thus, the upper layer 21 of an acoustic module 20 is preferably formed from a material which is hard wearing and aesthetically pleasing. As shown in FIG. 4, the upper layer 21 is formed from a tufted material, such as a tufted polyamide (PA6 or PA6.6) or tufted polypropylene. However, it will be appreciated that the upper layer 21 of the acoustic modules 20 may be formed from other materials depending upon the requirements of the vehicle manufacturer. Examples of other materials which may be used to form the upper layer 21 include: PVC; TPO; TPE; rubber; non-woven thermally bonded material; non-woven mechanically bonded material; metals; timber and cellulose materials.

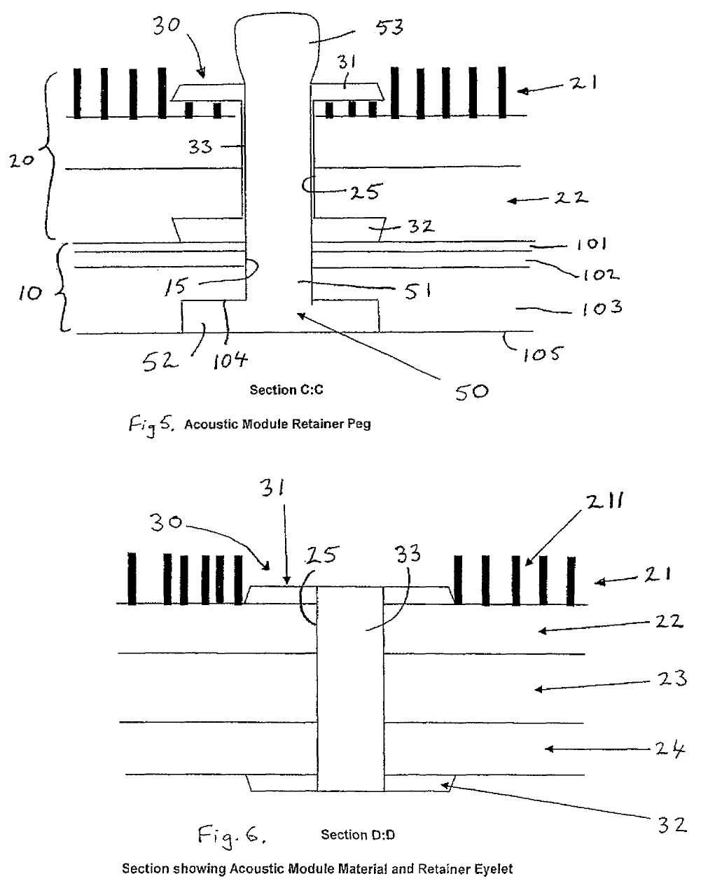

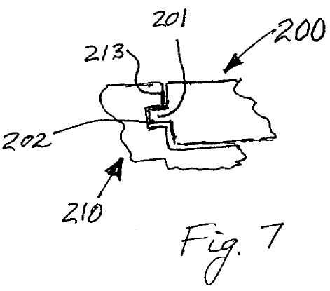

The acoustic module 20 may include a plurality of acoustic layers 22, 23 and 24 as shown in FIG. 6, depending upon the requirements of the vehicle areas where the vehicle carpet system is to be installed. For instance, the module 20 may have a tufted upper layer 21 providing the “A” surface, a first acoustic layer 22 providing a “B” surface below the layer 21, a second acoustic layer 23 forming a “C” surface below layer 22, and a third acoustic layer 24 forming the lowermost or “D” surface. The materials from which the acoustic layers 22, 23 and 24 are formed may be selected according to the particular acoustic requirements for the areas where the acoustic modules 20 are to be located in the vehicle carpet system. They are preferably selected from the range of acoustic materials from which the acoustic layer 22 of FIG. 4 may be formed. For instance, the acoustic layer 22 may be formed from a heavy layer of EVA or EDPM, the layer 23 may be farmed from a fibrous web of Hi-Loft felt, and the lower acoustic layer 24 may be formed from polyurethane foam. In some cases where different materials are used it may be necessary to provide one or more retainers 30 to retain the layers of the acoustic module 20 securely together.

As shown in FIG. 6, the retainer 30 comprises upper and lower retaining members 31 and 32 joined by a retaining rod or tube 33 which extends through an aperture 25 in the acoustic layers 22, 23 and 24. The upper retaining member 31 is in the form of a plate or ring which engages with the upper surface of acoustic layer 22, and the lower retaining member 32 is in the form of a plate or ring which engages with the lower surface of acoustic layer 24. The upper retaining member 31 is provided in an area where the tufts 211 of the tufted upper layer 21 are omitted. The upper and lower retaining members 31 and 32 and the retaining rod or tube 33 may be made from metal, plastics or other suitable material.

Referring to FIG. 5, a retaining member 50 in the form of a peg is used to retain an acoustic module 20 securely in position in a recess 12 of the carpet base 10.

The retaining member or peg 50 has an elongate shaft 51 extending from a base plate 52 and an enlarged head 53 on the end of the shaft 51. The base plate 52 sits within a recessed portion 104 in the lower surface 105 of the lower layer 103 of the carpet base 10. The shaft 51 of the peg 50 extends upwardly from the base through apertures 15, 25 in the carpet base 20 and acoustic module 10. The enlarged head 53 of the retaining peg 50 is engageable with the upper layer 21 of the acoustic-module 20. If a retainer 30 similar to that of FIG. 6 is used to hold the layers 21, 22 of the acoustic module 20 together, the elongate part 33 of the retainer 30 is preferably in the form of a hollow tube which allows the shaft 51 to extend through the acoustic module 20.

The modular carpet system of the present invention described above provides several advantages over conventional vehicle carpet systems. The molded carpet base 10 can be manufactured at a low cost, and even if a relatively expensive tufted or woven materials is used for the upper layer 21 providing the “A” surface of the acoustic modules 20, the overall cost of the carpet system is significantly reduced compared to conventional carpet systems because the tufted or woven material of the acoustic module is provided only in relatively small areas, such as the foot wells of the vehicle.

Another advantage provided by the module carpet system is that it allows the total weight of the system to be reduced because it is not necessary to use a thick, heavy sound-absorbing layer throughout the carpet system. Instead, the use of heavy sound-absorbing materials can be restricted to specific areas of the carpet system where recesses 12 are provided for receiving the acoustic modules 20. The reduction in weight achieved from customization of the type and location of the sound-absorbing and noise attenuating materials can lead to improved fuel usage and also enables the carpet system to meet increased acoustic requirements of the automotive industry.

The functionality of the modular carpet system is greatly enhanced by the ability to provide the acoustic modules in high wear areas and to be tuned for both noise and durability. This allows the use of appropriate materials to meet the changing needs of the automotive industry.

The modular carpet system with its lock-in acoustic modules 20 securely retained in recesses 10 in the carpet base provides additional safety by avoiding the problem when loose mats are used in foot wells and can ride up into the pedal box area of the driver's foot well.

In today's changing world, the need for recyclability is increasing. The modular carpet system provides the ability to use compatible materials in the layers of the carpet base 10 which can be recycled together. By providing acoustic modules 20 as removable components which can be removed for cleaning or replacement after wear, the modules 20, which may be formed of different materials from those of the molded carpet base 10, can be recycled separated from the base 10. This is in contrast to multi-layered single piece vehicle carpet systems which may be formed from incompatible materials which are not readily recyclable together.

It will be appreciated that various modifications may be made to the preferred embodiments described above without departing from the scope and spirit of the invention. For instance, different types of retaining means other than those of FIGS. 5 and 6 may be used to retain the acoustic modules 20 and the carpet base 10 together. Also, the undercut side walls 13 can be sloped in the opposite direction or even vertical. In these cases, as shown in FIG. 7, the retaining means can be a tab 201 formed on a side wall of the acoustic module 200 that cooperates with a slot 202 formed in a side wall 213 of the recess in the carpet base 210.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A carpet system for vehicles comprising:
a continuous carpet base molded to a shape of a vehicle floor in which the carpet system is to be installed, said carpet base including at least one layer of a molded noise-attenuating material and at least one molded recess being formed in said carpet base; and
at least one removable acoustic module which is adapted to be removably fitted into said at least one recess in said carpet base.

2. The carpet system according to claim 1 wherein said carpet base is formed from at least two layers having different material properties.

3. The carpet system according to claim 2 wherein said carpet base has at least one lower layer of noise-attenuating material, and an upper layer having an exposed upper surface.

4. The carpet system according to claim 3 wherein said noise-attenuating material from which said at least one lower layer is formed is selected from a group including a fibrous web, a Hi-Loft felt material and polyurethane foam.

5. The carpet system according to claim 3 wherein said upper layer is formed from a material selected from a group including a non-woven thermally bonded material, a non-woven mechanically bonded material, polyvinylchloride (PVC), a thermoplastic olefin (TPO), a thermoplastic elastomer (TPE), a tufted polyamide and a tufted polypropylene.

6. The carpet system according to claim 3 wherein said carpet base has at least one intermediate acoustic layer between said upper and lower layers of said carpet base.

7. The carpet system according to claim 6 wherein said intermediate acoustic layer is formed from one of a fibrous web, a felt material, a heavy layer of ethylene vinyl acetate (EVA), and ethylene-propylene-diene monomer (EPDM).

8. The carpet system according to claim 1 wherein said at least one acoustic module is formed from an upper layer having an exposed upper surface and at least one lower acoustic layer having sound-absorbing or noise-attenuating properties.

9. The carpet system according to claim 8 wherein said at least one lower acoustic layer is formed from at least one material selected from a heavy layer of EVA or EPDM, a fibrous web or felt material, PVC, TPO, TPE, polyurethane foam, polyester foam, a non-woven thermally bonded material and a non-woven mechanically bonded material.

10. The carpet system according to claim 8 wherein said upper layer of said acoustic module is formed from at least one of a group of materials selected from a tufted polyamide, a tufted polypropylene, PVC, TPO, TPE, rubber, a non-woven thermally bonded material, a non-woven mechanically bonded material, a metal, timber and a cellulose material.

11. The carpet system according to claim 8 wherein said layers of said acoustic module are retained securely together by a retainer having an upper retaining member which engages an upper surface of said upper layer and a lower retaining member which engages with a lower surface of said at least one lower layer.

12. The carpet system according to claim 1 further including retaining means for retaining said at least one acoustic module securely in position in said at least one recess in said carpet base.

13. The carpet system according to claim 12 wherein said retaining means is formed by an undercut side wall of said at least one recess and a transverse dimension of said at least one acoustic module is slightly greater than a mouth of said at least one recess so that said at least one acoustic module is securely retained by said undercut side wall when inserted into said at least one recess.

14. The carpet system according to claim 12 wherein said retaining means comprises at least one retaining member which extends through apertures in said at least one acoustic module and said carpet base.

15. The carpet system according to claim 14 wherein said retaining member has an elongate shaft, a base plate at one end of said shaft engageable with a lower surface of said carpet base and an enlarged head at an opposite end of said shaft engageable with an upper surface of said at least one acoustic module.

16. The carpet system according to claim 12 wherein said retaining means comprises at least one tab extending from said at least one acoustic module and releasably engaging an associated slot formed in a side wall of said at least one recess of said carpet base.

17. A carpet system for vehicles comprising:
a continuous carpet base molded to a shape of a vehicle floor in which the carpet system is to be installed, said carpet base including at least one layer of a molded noise-attenuating material and at least one molded recess being formed in said carpet base in each of an area a front seat foot well and a rear seat foot well; and
at least one removable acoustic module which is adapted to be removably fitted into each of said recesses.
